(19) United States
(12) Patent Application Publication
(10) Pub. No.: US 2008/0258323 A1
(43) Pub. Date: Oct. 23, 2008

(54) Method for making a bamboo tool handle

(76) Inventor: Yi-Kung Hung, Lukang Chen (TW)

Correspondence Address: BACON & THOMAS, PLLC, 625 SLATERS LANE, FOURTH FLOOR, ALEXANDRIA, VA, 22314-1176, US

(21) Appl. No.: 11/785,784

(22) Filed: Apr. 20, 2007

(51) Int. Cl. C01B 31/00

(52) U.S. Cl. 264/29.4

(57) ABSTRACT

A method for making a bamboo-made tool handle, has the following steps. A bamboo material is cut into multiple bamboo strips. Green skins of the bamboo strips are removed to obtain original bamboo strips. The original bamboo strips are steamed with hydrogen peroxide and dried to obtain dried bamboo strips. The dried bamboo strips is turned to obtain turned bamboo woods. The turned bamboo wood is carbonized to obtain carbonized bamboo woods. The carbonized bamboo wood is combined to obtain a bamboo wood bundle, wherein each carbonized bamboo woods are combined at a longitudinal direction. The method for making a bamboo-made tool handle is convenient and could obtain an elastic and tough bamboo tool handle.

### BACKGROUND OF THE INVENTION

1. Field of the Invention

The present invention relates to a method for making a bamboo tool handle.

2. Description of the Related Art

A conventional tool handle is always made of wood, but wood is gained from trees and is a non-elastic material. Trees need a long period for growth and to obtain a suitable trees is difficult. Therefore, cost for using wood is high but limited.

To overcome the shortcomings, the present invention provides a bamboo tool handle to obviate or mitigate the aforementioned problems.

### SUMMARY OF THE INVENTION

The primary objective of the present invention is to provide a bamboo tool handle that is simplified and convenient to use.

A method for making a bamboo tool handle, has the following steps. A bamboo material is cut into multiple bamboo strips. Green skins of the bamboo strips are removed to obtain original bamboo strips. The original bamboo strips are steamed with hydrogen peroxide and dried to obtain dried bamboo strips. The dried bamboo strips is turned to obtain turned bamboo woods. The turned bamboo wood is carbonized to obtain carbonized bamboo woods. The carbonized bamboo wood is combined to obtain a bamboo wood bundle, wherein each carbonized bamboo woods are combined at a longitudinal direction. The method for making a bamboo tool handle is convenient and could obtain an elastic and tough bamboo-made tool handle.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a bamboo-collecting step of a method in accordance with the present invention;

FIG. 2 is an exploded perspective view of bamboo-cutting step of a method in accordance with the present invention;

FIG. 3 is operational side views of a preparing bamboo wood step of a method in accordance with the present invention;

FIG. 4 is an operational perspective view of a gluing bamboo woods step of a method in accordance with the present invention to glue bamboo woods together on a gluing machine;

FIG. 5 is operational side views of a pressing bamboo woods step of a method in accordance with the present invention;

FIG. 6 is operational perspective views of a turning bamboo woods step of a method in accordance with the present invention;

FIG. 7 is an end view of a first embodiment of a bamboo wood bundle with different hardness of bamboo woods;

FIG. 8 is an end view of a second embodiment of a bamboo wood bundle with different hardness of bamboo woods; and

FIG. 9 a perspective view of a tool with a bamboo tool handle in accordance with the present invention.

### DETAILED DESCRIPTION OF THE INVENTION

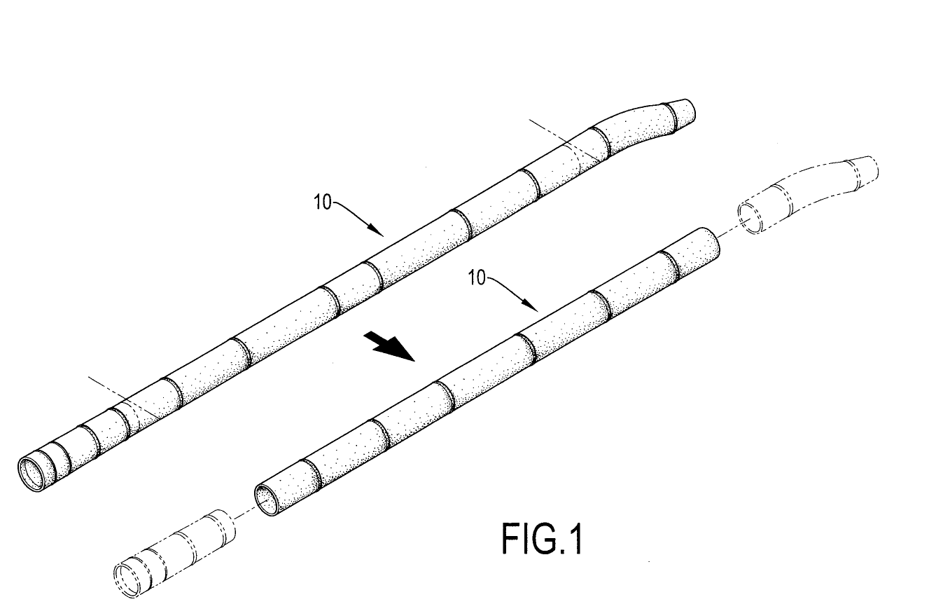

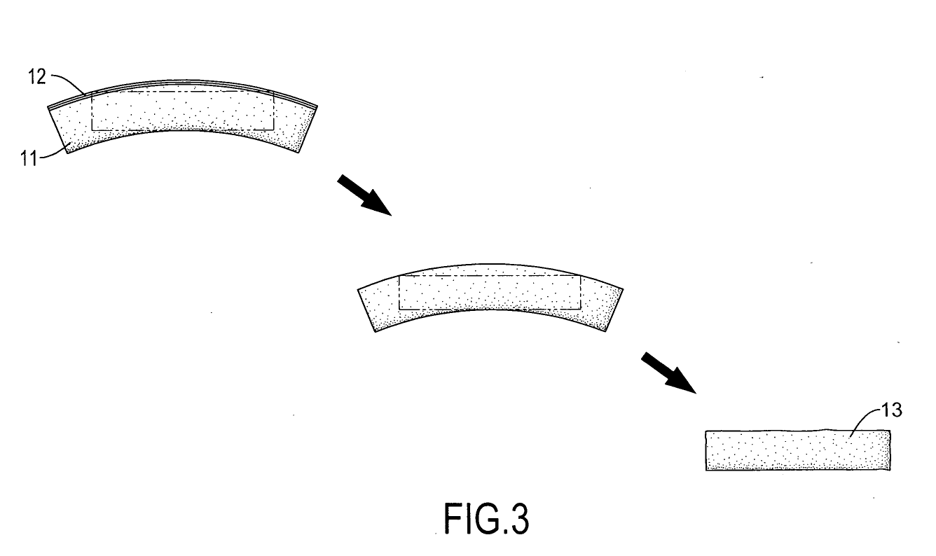

With reference to FIGS. 1 to 3, the present invention relates to a method for making a bamboo tool handle, and the method is described as follows.

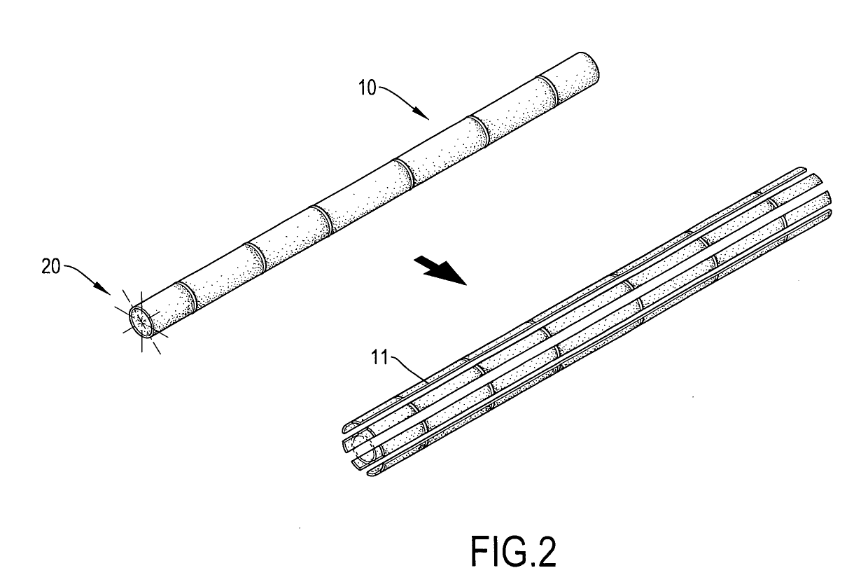

A bamboo-collecting step, wherein the collected bamboo is cut to remove the top, the tail and the rough part of bamboo and a bamboo material is obtained. The bamboo material is divided into multiple original bamboo strips (11) as shown in FIG. 2. Because the original bamboo strips are hard to combine together when the original bamboo strips (11) with green skin (11), the original bamboo strips (11) were peeled to remove the green skin (12) of the original bamboo strips (11) to obtain bamboo strips. In a preferred embodiment, the thickness of each bamboo strips is about 7 to 8 mm.

The original bamboo strips were steamed with hydrogen peroxide at 100° C. for 2 to 3 hours. This step is used for bleaching and disinfecting the bamboo strips. The steaming condition is depended on the concentration of hydrogen peroxide, when the bamboo strips were steamed with low concentration of hydrogen peroxide, the steaming time may be longer than that for being steamed with high concentration of hydrogen peroxide. Then, the steamed bamboo strips may be dried at 60 to 70° C. for 72 hours if the bamboo strips have a thickness about 7 to 8 mm. Dried condition depends on the thickness of the steamed bamboo strips. In a preferred embodiment, water content of the steamed bamboo strips are less than 10 degree. The dried bamboo strips were optionally carbonized at 120° C. for 2 hours to make the dried bamboo strips show a desired color. The carbonized bamboo strips were burnished to obtain bamboo wood (13). In a preferred embodiment, the bamboo wood (13) may show rectangle shape in cross section.

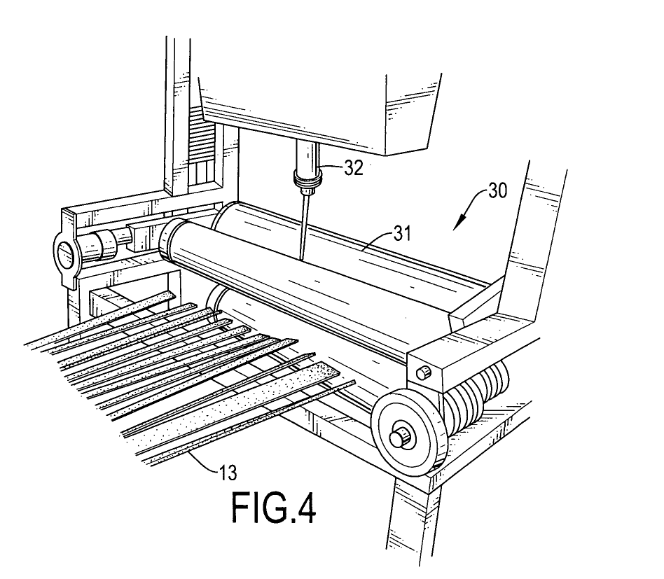

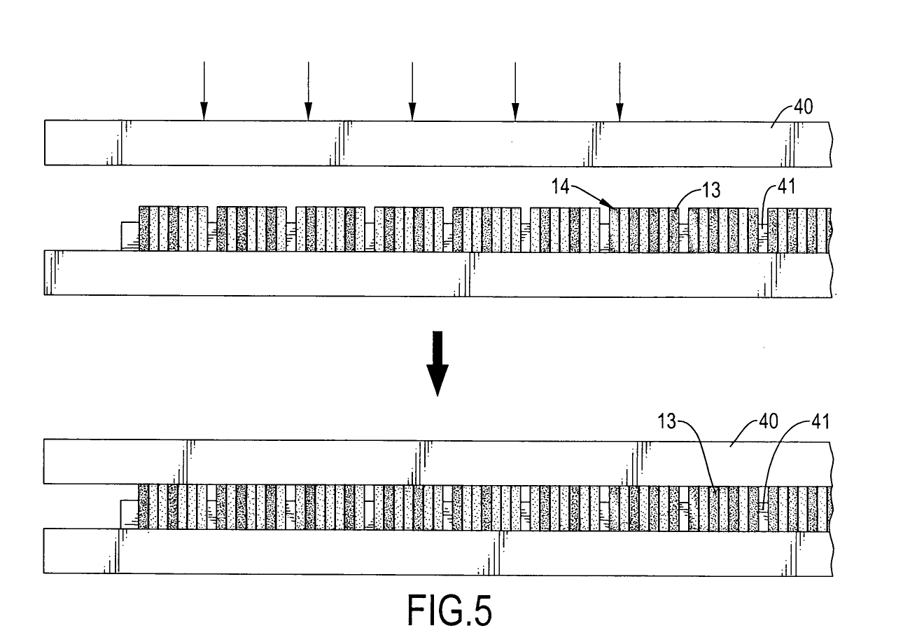

With reference to FIGS. 4 and 5, multiple bamboo woods (13) were selected and put on a glue machine (30) for putting glue on the bamboo wood (13). In a preferred embodiment, the glue machine (30) has a top and a bottom press rollers (31), and a glue outlet (32) located toward the top and the bottom press rollers (31). The bamboo woods (13) are located between the top and the bottom rollers (31) and a glue is put onto the bamboo woods (13) with the rotation of the rollers (31). The bamboo woods (13) with glue are put together to form a bamboo wood bundle (14) by a binding machine (40). The numbers of bamboo woods for forming the bamboo wood bundle (14) depend on different needs. Each bamboo wood bundle (14) may separate by a spacer (41). After the bamboo wood bundle (14) are formed, the bamboo wood bundle (14) is pressed for 10 to 15 minutes. The time for pressing depends on the thickness of bamboo wood bundle (14). Finally, the pressed bamboo wood bundle (14) was carbonized again at 120° C. for about 2 hours to enhance the strength of the bamboo wood bundle (14).

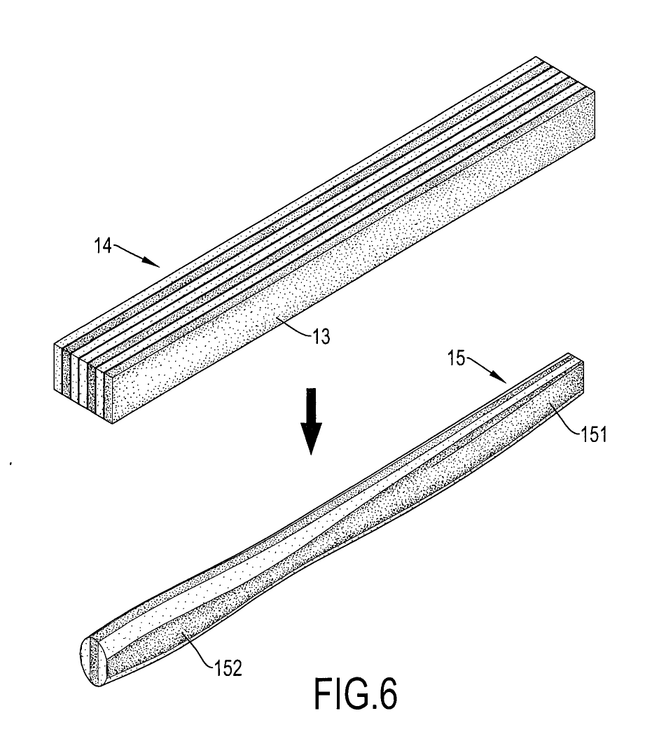

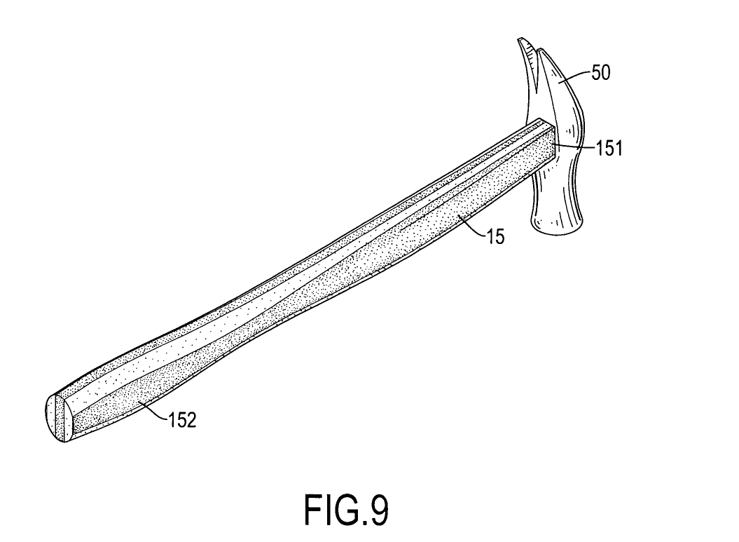

With reference to FIGS. 6 and 9, each bamboo wood (13) of the treated bamboo wood bundle (14) was combined at a longitudinal direction. The bamboo wood bundle (14) are turned as a desired shape, such as a tool handle (15). The tool handle (15) may have an inserted end (151) and a handle part (152).

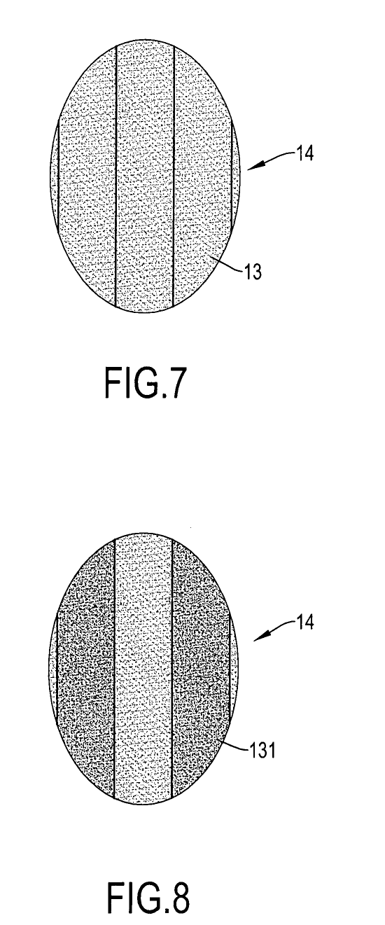

With reference to FIGS. 7 and 8, the bamboo woods (13) for forming the bamboo wood bundle (14) may comprise different carbonized levels to enhance the strength of the bamboo wood bundle (14).

The advantages of the bamboo wood bundle are described as follows.

Bamboo is available easily and the weight of bamboo is light. Bamboo is an elastic and tough material. Therefore, a bamboo handle will reduce the cost due to available easily, and increase value of bamboo.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for making a bamboo-made tool handle, comprising
cutting a bamboo material into multiple bamboo strips,
removing green skins of the bamboo strips to obtain original bamboo strips,
steaming and drying the original bamboo strips with hydrogen peroxide to obtain dried bamboo strips,
turning the dried bamboo strips to obtain turned bamboo woods,
carbonizing the turned bamboo wood to obtain carbonized bamboo woods, and
combining the carbonized bamboo wood to obtain a bamboo wood bundle, wherein each carbonized bamboo woods are combined at a longitudinal direction.

2. The method as claimed as claim 1, wherein the water content of each bamboo wood is less than 10 degree.

3. The method as claimed as claim 4, wherein the original bamboo strips with thickness of 7 to 8 mm are dried at 60 to 70° C. for 72 hours.

4. The method as claimed as claim 3, wherein the dried bamboo strips are further treated with carbonized procedure.

5. The method as claimed as claim 4, wherein carbonized procedure is processed at 120° C. for 2 hours.

6. The method as claimed as claim 1, wherein original bamboo strips are further processed at 120° C. for 2 hours for carbonization.
